(19) United States
(12) Patent Application Publication
(10) Pub. No.: US 2007/0035631 A1
(43) Pub. Date: Feb. 15, 2007

(54) Electronic image pickup device with hand-shake compensation function and camera-equipped portable electronic device

(75) Inventor: Minoru Ueda, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/502,273

(22) Filed: Aug. 9, 2006

(30) Foreign Application Priority Data
Aug. 11, 2005 (JP) 2005-233025

(51) Int. Cl. G03B 17/00; H04N 5/228

(52) U.S. Cl. 348/208.99; 396/55

(57) ABSTRACT

There is provided an electronic image pickup device with a hand-shake compensation function capable of reducing drive amount necessary for shake compensation and achieving downsizing without increasing a size of a piezoelectric element or voltage to be applied. A lens L2 is attached to an output-side surface of a prism P1 for bending an optical axis, and the prism P1 and the lens L2 are integrated together. Upon occurrence of a hand-shake vibration, as the prism P1 is rotationally driven by a drive member 17, the lens L2 is also translated in a direction approximately perpendicular to the optical axis. By the moves of both prism P1 and lens L2, hand-shake compensation can be achieved with a small drive amount. Thus, the drive member 17 can be made smaller-size and compact, and the electronic image pickup device with a hand-shake compensation function can be reduced in size.

This nonprovisional application claims priority under 35 U.S.C. §119(a) on Patent Application No. 2005-233025 filed in Japan on Aug. 11, 2005, the entire contents of which are hereby incorporated by reference.

### BACKGROUND OF THE INVENTION

The present invention relates to an electronic image pickup device with a hand-shake compensation function, as well as camera-equipped portable electronic device, which is, for example, among camera-equipped portable electronic devices, capable of preventing image blurs due to hand shakes and vibrations or the like. In particular, the invention relates to an electronic image pickup device with a hand-shake compensation function, as well as camera-equipped portable electronic device, capable of making hand-shake compensations by driving a bending member for bending an optical axis in a bent optical system.

In shooting with a camera-equipped portable electronic device, if an electronic image pickup device is given vibrations due to hand-shake vibrations or the like, the image forming position of the subject with respect to the light-receiving surface is changed, causing the image to roll up or down with a result of an unclear picked-up image. Thus, there has been proposed a camera-equipped portable electronic device with a hand-shake compensation function capable of eliminating image blurs by, upon a shake of the camera-equipped portable electronic device with respect to the subject, deflecting the optical axis of the optical system to compensate a shift of the image forming position of the subject with respect to the camera. Methods for such hand-shake compensation include one in which a correcting lens is translated in a direction orthogonal to the optical axis (JP H04-180040 A: Patent Document 1), and another in which the input or output plane of an apical-angle variable prism is varied (JP H05-11304 A: Patent Document 2).

Also, in recent years, there have been provided cameras which are advanced toward smaller thicknesses and sizes by using a bending optical system in which the optical axis is bent. In such a bending optical system, the reflecting surface of the bending member for bending the optical axis is moved to obtain a hand-shake compensation function without sacrificing the thinness of the camera (JP 2004-219930 A: Patent Document 3).

For a piezoelectric element to be used as a drive member for hand-shake compensation in small-size cameras, its displacement amount depends generally on a size of the piezoelectric element and an applied voltage, so that obtaining a large displacement amount involves upsizing the piezoelectric element or applying a higher voltage.

Meanwhile, camera-equipped portable telephones, which are under a demand for smaller sizes and which have a difficulty in use of a high voltage, are required that the drive amount of their shake compensation part should be as small as possible.

Therefore, even with the electronic image pickup device with the hand-shake compensation function of Patent Document 3, in which the reflecting surface of the bending member for bending the optical axis is moved, the drive amount of the reflecting surface for hand-shake compensation is still so large that the drive member cannot be reduced in size to an enough extent.

### SUMMARY OF THE INVENTION

Accordingly, an object of the present invention is to provide an electronic image pickup device with a hand-shake compensation function which is capable of reducing the drive amount necessary for hand-shake compensation with a simple structure and thereby implementing downsizing of the drive member.

In order to achieve the above object, there is provided an electronic image pickup device with a hand-shake compensation function comprising: a bending member for bending an optical axis; a lens system for receiving light derived from the bending member; an image pickup element on which an image of a subject is formed by the light derived from the lens system; and a drive member for driving the bending member, in which upon occurrence of a hand-shake vibration, the bending member is driven by the drive member so that a shift of the subject image is compensated, wherein

the bending member and at least one lens in the lens system are integrated together.

According to the above structure, the bending member is moved integrally with the lens by the drive member upon occurrence of a hand-shake vibration. Accordingly, both the bending member and the lens act to correct the blur of the subject image, so that the drive amount of the bending member required upon occurrence of a hand shake can be reduced and therefore a reduction in size of the drive member for driving the bending member can be achieved.

In an embodiment, the bending member is a prism, and the lens is attached to the prism.

In this embodiment, since the lens is attached to the prism, those members are compactly integrated together with simplicity and low cost.

Still, since the prism integrated with the lens can be driven by a drive member absolutely identical to the conventional drive member that drives the prism alone, a large hand-shake compensation amount can be obtained by displacing the lens and the prism with the same drive member as the conventional.

In an embodiment, the bending member and the lens are fixed to one common fixing member.

In this embodiment, since the bending member and the lens are fixed to one common fixing member, the distance from the rotational center of the bending member to the lens can be increased, as compared with the case where the lens is fixed directly to the bending member. Accordingly, the amount to which the lens is moved in a direction approximately orthogonal to the optical axis together with the rotational move of the bending member can be increased, so that the amount of hand-shake compensation can be increased and that the amount of drive by the drive member can be reduced. Thus, the electronic image pickup device with a hand-shake compensation function can be made smaller in size and compact.

Also, since the bending member and the lens are fixed to one common fixing member so as to be integrated together, it becomes practicable that the bending member and the lens are fitted to the fixing member so as to be integrated together and made drivable, even when the bending member is such a mirror that the lens cannot be attached thereto. Accordingly, the drive amount of the bending member such as a mirror required upon occurrence of a hand shake can be reduced, so that the drive member can be made smaller in size.

Further, since the bending member and the lens are fixed to one common fixing member, the structure for integration of those members becomes simple and their assembly can be facilitated.

In an embodiment, the bending member is a mirror.

There is provided a camera-equipped portable electronic device including the electronic image pickup device with a hand-shake compensation function.

Since the camera-equipped portable electronic device of this embodiment includes the electronic image pickup device with a hand-shake compensation function capable of realizing a size reduction of the drive member, a size reduction of the camera-equipped portable electronic device can be reduced in size.

According to the present invention, the bending member and the lens are integrated together, and the lens is driven together with the bending member by the drive member upon occurrence of a hand-shake vibration. Thus, the drive amount of the bending member can be reduced, so that a downsizing of the drive member for the bending member can be achieved.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a view showing a camera unit in which a lens is attached to a prism according to an embodiment of the present invention;

FIG. 2 is a view showing a camera unit in which a mirror and a lens are fixed to one common holder according to an embodiment of the invention;

FIG. 3 is a view showing a camera unit in which a prism and a lens are integrated together according to an embodiment of the invention;

FIG. 4 is a view showing a zooming state of the camera unit in the embodiment;

FIG. 5 is a graph showing a relationship between hand-shake amount and drive amount of a drive member;

FIG. 6 is a perspective view for explaining a first image-taking mode of a camera-equipped portable telephone containing an electronic image pickup device with a hand-shake compensation function according to the invention;

FIG. 7 is a perspective view for explaining a second image-taking mode of the portable telephone; and

FIG. 8 is a block diagram of main part of a camera-equipped portable telephone containing the camera-use shake compensation unit according to the invention.

### DETAILED DESCRIPTION OF THE INVENTION

Hereinbelow, a camera-equipped portable electronic device using an electronic image pickup device with a hand-shake compensation function according to the present invention will be described in detail by way of embodiments thereof illustrated in the accompanying drawings.

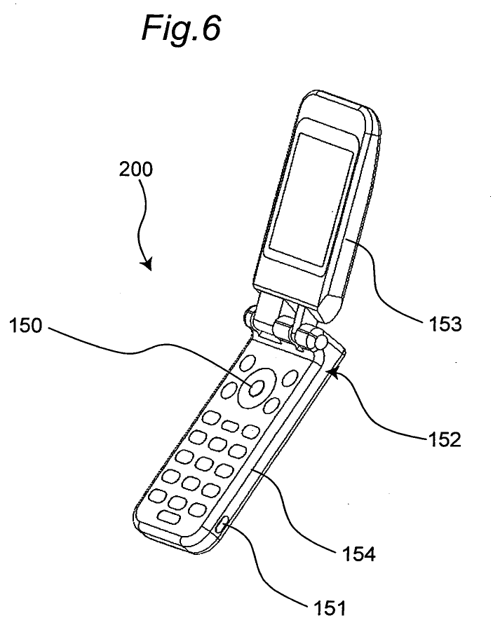

First of all, a camera-equipped portable telephone as an example of a camera-equipped portable electronic device including an electronic image pickup device with a hand-shake compensation function according to the present invention will be explained with reference to FIGS. 6 to 8.

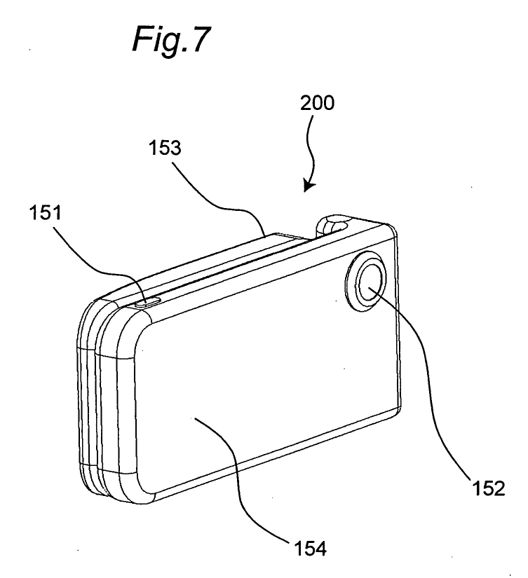

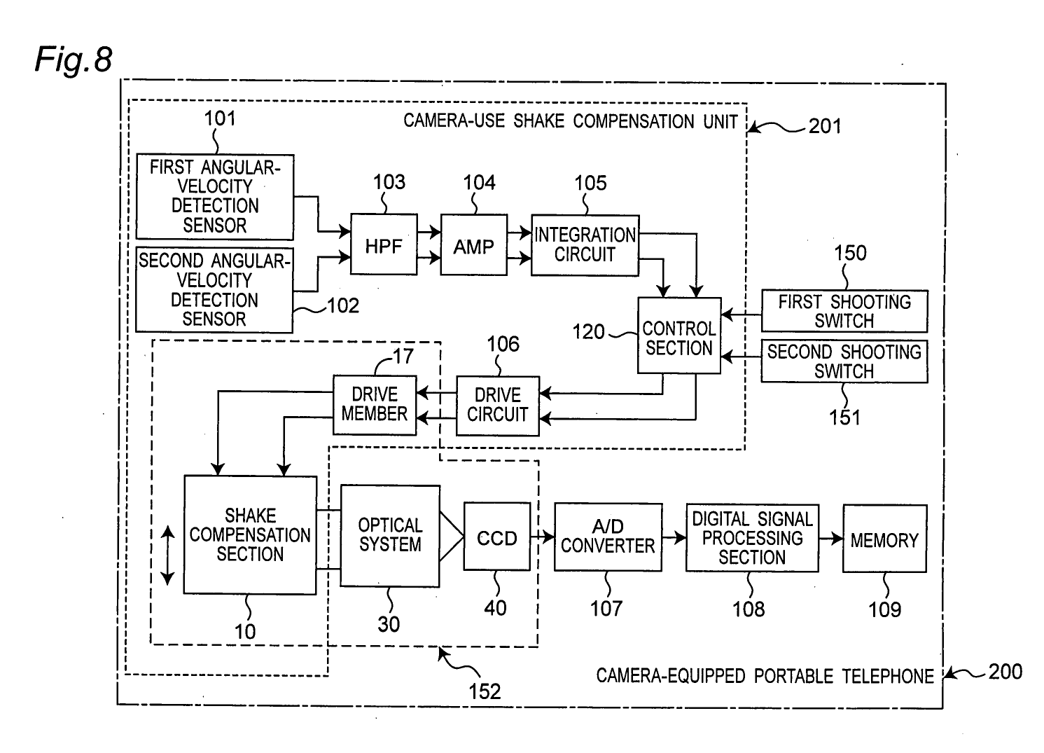

FIG. 6 is a perspective view showing an image-taking mode of a camera-equipped portable telephone 200 with a camera-use shake compensation unit contained therein. FIG. 7 is a perspective view of the camera-equipped portable telephone 200 of which a cover portion is closed as viewed from the rear side. Also, FIG. 8 is a block diagram of main part of the camera-equipped portable telephone 200 including the camera-use shake compensation unit 201.

Referring to FIGS. 6 and 7, the camera-equipped portable telephone 200 is composed roughly of a portable telephone main body 154 on which various dial buttons and operation buttons are provided, and a cover portion 153 which is rotatably connected to the portable telephone main body 154 with a hinge and which has a display screen provided therein. Then, by operating a first shooting switch 150 provided on an operation face or a second shooting switch 151 provided on a side face in the portable telephone main body 154, image taking is done by a camera unit 152 which is an example of an electronic image pickup device with a hand-shake compensation function mounted in the portable telephone main body 154.

Operation in this image taking is explained with reference to the block diagram of FIG. 8. Referring to FIG. 8, the camera-equipped portable telephone 200 is composed roughly of the camera-use shake compensation unit 201, a camera unit 152, an A/D converter 107 for converting an analog image signal derived from the camera unit 152 from analog to digital form, a digital signal processing section 108 for processing a digital signal derived from the A/D converter 107, and a memory 109 for storing therein an image subjected to signal processing by the digital signal processing section 108.

Also, the camera-use shake compensation unit 201 has a first angular-velocity detection sensor 101 implemented by a gyro sensor or the like as an example of a hand shake detection sensor, a second angular-velocity detection sensor 102 implemented by a gyro sensor or the like as an example of the hand shake detection sensor, an HPF (High-Pass Filter) 103 for removing DC (Direct Current) components from angular-velocity signals derived from the first, second angular-velocity detection sensors 101, 102, an AMP (Amplifier) 104 for amplifying an angular-velocity signal derived from the HPF 103, and an integration circuit 105 for integrating an angular-velocity signal derived from the AMP 104 to determine an angular signal. Then, upon receiving an operation signal from the first shooting switch 150 or the second shooting switch 151 shown in FIGS. 6 and 7, a control section 120 generates and outputs a control signal for controlling a shake compensation section 10 on the basis of the angular signal derived from the integration circuit 105. A drive circuit 106 generates and outputs a drive signal on the basis of the control signal derived from the control section 120. Then, drive members 17 are driven by a drive signal derived from the drive circuit 106 to drive the shake compensation section 10 in orthogonal two-axis directions, by which hand-shake compensation is performed.

That is, the shake compensation section 10 is displaced so as to cancel a pitching angle and a yawing angle which are determined based on angular-velocity signals derived from the first angular-velocity detection sensor 101 and the second angular-velocity detection sensor 102. Then, via the optical system 30, an image of the subject is taken into a CCD (Charge Coupled Device) 40 which is an example of the image pickup element. An analog image signal from the CCD 40 obtained in this way is converted from analog to digital form by the A/D converter 107, a digital signal from the A/D converter 107 is processed by the digital signal processing section 108, and a resulting image signal is stored in the memory 109.

The camera unit 152 is composed of the drive member 17, the shake compensation section 10, the optical system 30 and the CCD 40.

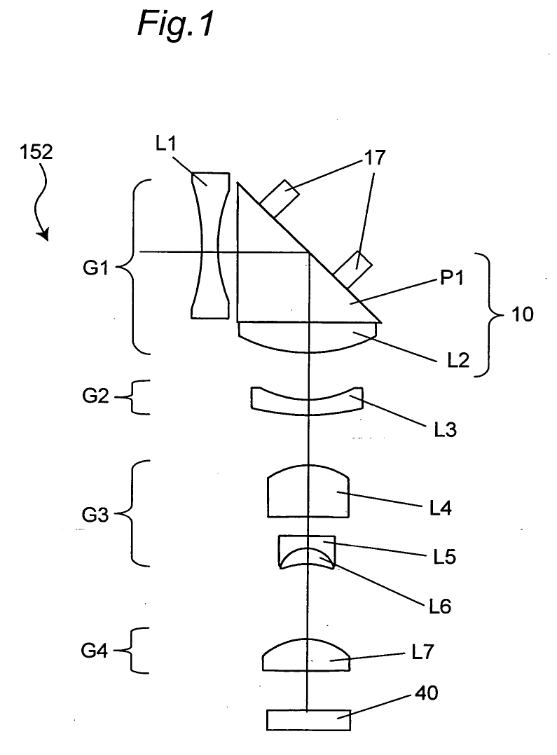

FIG. 1 is a view showing the camera unit 152 in detail.

The camera unit 152 includes, as listed from the subject side, a first lens group G1, a second lens group G2, a third lens group G3 and a fourth lens group G4, and moreover the CCD 40 on which light transmitted by the individual lens groups in sequence is focused to form an image. The second lens group G2, the third lens group G3 and the fourth lens group G4 correspond to the optical system 30 of the FIG. 8.

The first lens group G1 is composed of a lens L1 on the subject side, a prism P1 as an example of the bending member for bending the optical axis, and a lens L2 for receiving light from the prism P1. The lens L2 is attached on a light-outputting side surface of the prism P1 so that the prism P1 and the lens L2 are integrated together. The prism P1 and the lens L2 constitute the shake compensation section 10.

On a sloped surface of the prism P1, drive members 17, 17 which are piezoelectric elements as an example are provided to perform hand-shake compensation by rotating the prism P1 in orthogonal two-axis directions.

The second lens group G2 is composed of a lens L3, the third lens group G3 is composed of lenses L4, L5, L6 arrayed in succession from the subject side, and the fourth lens group G4 is composed of a lens L7.

In this construction, as the prism P1 is rotationally driven by the drive members 17, 17, the lens L2 also is moved in a direction approximately orthogonal to the optical axis together with the rotation of the prism P1 because the prism P1 and the lens L2 are integrated together. Therefore, larger amounts of hand-shake compensation can be achieved with smaller amounts of drive by the drive members 17, 17, so that the drive members 17, 17 can be reduced in size.

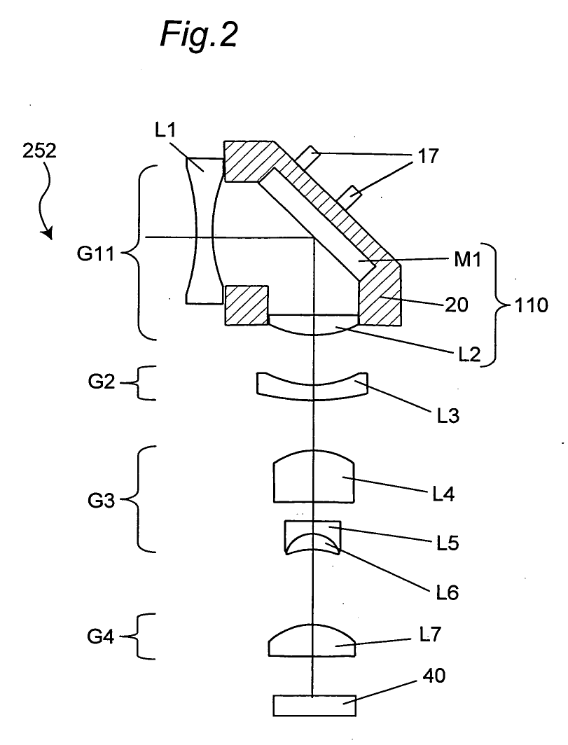

FIG. 2 is a view showing main part of a camera unit 252 as an electronic image pickup device with the hand-shake compensation function according to another embodiment of the invention. In FIG. 2, like component members in conjunction with FIG. 1 are designated by like reference numerals and their detailed description is omitted.

In the camera unit 252, a first lens group G11 composed of a lens L1 provided on the subject side, a mirror M1 as an example of the bending member for bending the optical axis and a lens L2 provided on the output side of the mirror M1, a second lens group G2 composed of a lens L3, a third lens group G3 composed of lenses L4, L5, L6, and a fourth lens group G4 composed of a lens L7 are arrayed in this order as mentioned from the subject side. Then, light inputted from the subject side is transmitted by the lens groups, forming an image to a CCD 40.

The mirror M1 and the lens L2 are fixed to a holder 20 as an example of one common fixing member so as to be integrated together. The holder 20 has a generally L-shaped passage, the mirror M1 is fixed on a slope part of an inner surface of the passage, and the lens L2 is fixed on an exit side of the passage. The mirror M1, the lens L2 and the holder 20 integrally constitute a shake compensation section 110.

On the holder 20 of the shake compensation section 110, drive members 17, 17 which are piezoelectric elements as an example are mounted to perform hand-shake compensation. The drive members 17, 17 are ready for drive in the two-axis directions orthogonal to the optical axis of incident light.

In this construction, since the mirror M1 and the lens L2 are integrated together by the holder 20, drive amounts of the shake compensation section 110, i.e. drive amounts of the drive members 17, 17, can be reduced, and therefore the drive members 17, 17 can be reduced in size, without providing any drive member or control circuit in addition to the conventional system in which only the prism is driven.

Also, since the mirror M1 and the lens L2 are fixed to one common holder 20, the distance from a rotational center of the mirror M1 to the lens L2 can be increased. Therefore, the move extent of the lens L2 in a direction approximately orthogonal to the optical axis caused by a rotational move of the mirror M1 can be increased, so that the amount of hand-shake compensation can be increased, allowing the drive amounts of the drive members 17 to be decreased. Consequently, the camera unit 252 can be made smaller in size and more compact.

Also, by the provision of the holder 20, even when the lens L2 cannot be attached to the mirror M1, the mirror M1 and the lens L2 can be integrated together via the holder 20.

The fixing member such as the holder 20 is not limited to mirrors, and may be applied to any type of bending member.

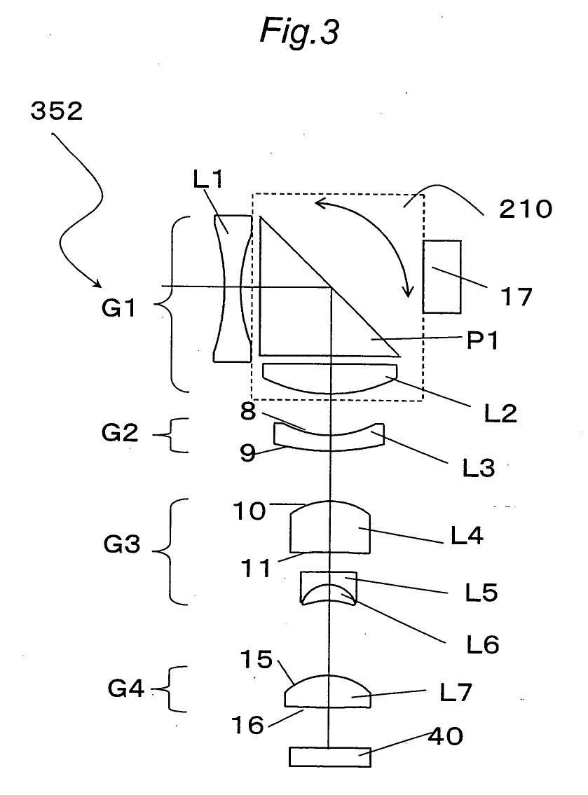

FIG. 3 is a view showing a camera unit 352 which is another embodiment of the invention. This camera unit 352 differs from the camera unit 152 of FIG. 1 in that the lens L2 is not attached to the prism P1, but the prism P1 and the lens L2 are fixed to an unshown fixing member. Therefore, in FIG. 3, like component members in conjunction with FIG. 1 are designated by like reference numerals and their detailed description is omitted.

The prism P1, the lens L2 and the fixing member are integrated together to constitute a shake compensation section 210. Upon occurrence of a hand-shake vibration, the fixing member is rotationally driven by a driving member 17, by which hand-shake compensation is performed as follows.

Upon occurrence of a hand-shake vibration, as the drive member 17 rotationally drives the fixing member, the prism P1 rotates with a reflecting surface (sloped surface) of the prism P1 inclined, causing the angle of reflection to change. As a result, the direction of the reflected ray is changed, by which an image blur in the image forming surface is corrected. Concurrently with this, the lens L2 is also translated in a direction approximately orthogonal to the optical axis, and therefore, the image blur in the image forming surface is corrected also by the approximate translation.

As shown above, by the prism P1 and the lens L2 being integrated together, effects by both a move of the prism P1 and a move of the lens L2 can be obtained with a single drive member 17, so that the drive amount of the drive member 17 can be reduced as compared with the system in which only the prism is driven. Therefore, the drive member 17, of which drive amount and drive force are proportional to its volume as in the case of a piezoelectric element, can be reduced in volume, so that the camera can be reduced in size.

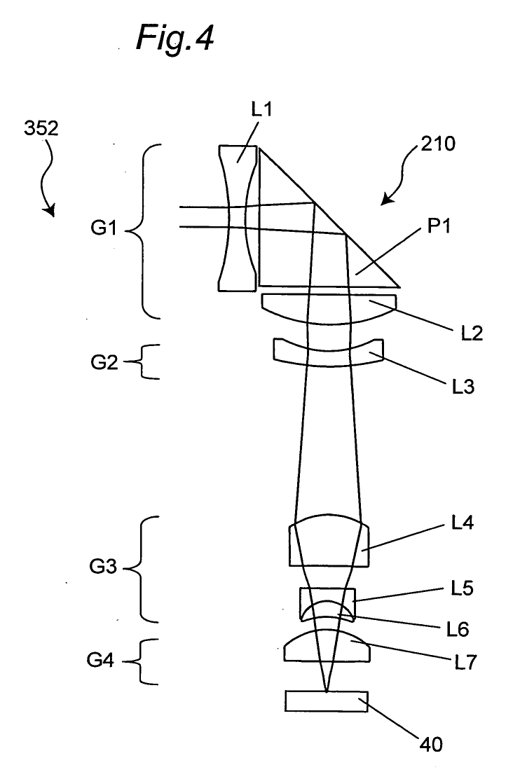

FIG. 4 is a view showing a state in which the second lens group G2 and the third lens group G3 have been moved along the optical axis in a zooming operation in the camera unit 352 of FIG. 3. It is noted that lenses L1, L7 are fixed lenses.

Detailed lens data of the optical system of the camera unit 352 are shown in Table 1 below. In the leftmost column in the table are numbers representing what ordinal number of place the lens surface counts as counted from the subject side. Reference character r represents the radius of curvature of a lens, d represents the lens thickness or lens interval, Nd represents the refractive index of a lens, and νd represents the Abbe's number. Also, given a cone constant of K and aspheric factors of A, B, C and D, the configuration of an aspheric surface is expressed by the following equations in an orthogonal coordinate system in which the surface vertex is assumed as an origin and the direction of the optical axis is assumed as a Z axis:

TABLE 1

| | r | d | Nd | νd |
|---|---|---|---|---|
| 1 | −13.63 | 1.00 | 1.85 | 23.80 |
| 2 | 9.69 | 1.09 | | |
| 3 | ∞ | 4.30 | 1.83 | 42.70 |
| 4 | ∞ | 4.30 | | |
| 5 | ∞ | 0.50 | | |
| 6 | ∞ | 1.90 | 1.80 | 35.00 |
| 7 | −8.61 | 2.00 | | |
| 8 | −5.13 | 1.00 | 1.82 | 46.60 |
| 9 | −10.61 | 9.09 | | |
| STOP | 4.28 | 3.29 | 1.81 | 40.90 |
| 11 | 90.51 | 1.15 | | |
| 12 | 726.27 | 0.80 | 1.85 | 23.80 |
| 13 | 1.70 | 1.00 | 1.79 | 47.40 |
| 14 | 4.09 | 0.80 | | |
| 15 | 3.67 | 2.00 | 1.53 | 56.20 |
| 16 | 3.88 | 1.96 | | |
| 16 | ∞ | | | |

(Equation 1)

$Z = \frac{{Y}^{2} / r}{1 + \sqrt{1 - ( 1 + K ) {Y}^{2} / {r}^{2}}} + A \times {Y}^{4} + B \times {Y}^{6} + C \times {Y}^{8} + D \times {Y}^{10}$

where Z is an Z coordinate, and

Y is a Y coordinate.

Aspheric Factors:

Eighth lens surface 8 (see FIG. 3)

K=−0.7539

A=1.5807×10⁻³

B=−9.5972×10⁻⁵

C=2.9693×10⁻⁶

D=9.3568×10⁻⁸

Ninth lens surface 9:

K=−11.1827

A=2.7404×10⁻⁴

B=−2.2679×10⁻⁵

Tenth lens surface 10:

K=0.1315

A=−1.2431×10⁻⁴

B=1.3049×10⁻⁵

C=4.1006×10⁻⁶

D=7.8747×10⁻⁷

Eleventh lens surface 11:

K=0

A=1.4053×10⁻³

B=7.1573×10⁻⁵

C=8.5625×10⁻⁵

D=6.3203×10⁻⁶

Fifteenth lens surface 15:

K=0.3872

A=−3.4765×10⁻³

B=1.0007×10⁻³

C=−2.6941×10⁻⁶

D=2.0564×10⁻⁵

Sixteenth lens surface 16:

K=0

A=−5.0676×10⁻³

B=2.1718×10⁻³

C=−6.1723×10⁻⁴

D=6.3089×10⁻⁵

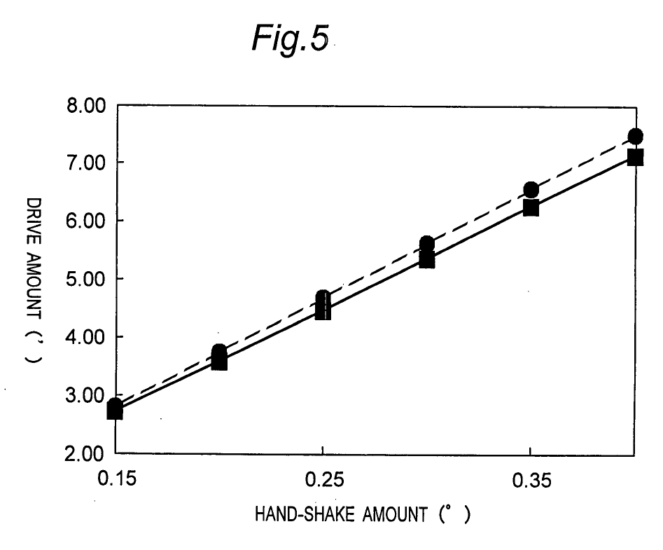

FIG. 5 is a graph showing a relationship between hand-shake amount and drive amount. In FIG. 5, in a camera unit in which the prism P1 and the lens L2 are separated from each other, a broken line interconnecting black circles represents the drive amount versus hand-shake amount in a case where upon an inclination of the camera unit due to a hand shake, the hand shake is corrected by exerting the drive by the drive member so that only the prism P1 is inclined in a direction opposite to that of the inclination of the camera unit. A solid line interconnecting black squares represents the drive amount versus hand-shake amount in the camera unit 352 of FIG. 4, in which the prism P1 and the lens L2 provided in its rear are integrated together, in a case where the prism P1 is inclined in a direction opposite to that of the inclination of the camera unit 352 by the drive exerted by the drive member 17.

As apparent from the graph of FIG. 5, the necessary drive amount can be made smaller in the case of the drive with the prism P1 and the lens L2 integrated together (shown by solid line) than in the case of the drive of only the prism P1 (shown by broken line). This is because in the case of the drive with the prism P1 and the lens L2 integrated together, there can be obtained two effects, i.e., one effect of the inclination of the prism P1 and the other effect of the translation of the lens L2 in the direction approximately perpendicular to the optical axis due to the inclination of the prism P1, as compared with the case where only the prism P1 is driven. Accordingly, as the rotational center of the prism P1 becomes farther from the lens L2, those effects become increasingly larger so that the drive amount of the drive member 17 can be made smaller. In the foregoing embodiment, since the drive amount can be reduced by about 5% at a maximum, the piezoelectric element as the drive member can be reduced in volume also by about 5%, thus allowing the drive member 17 to be more compact.

In the foregoing embodiment, the lens closest to the output side of the bending member is integrated with the bending member. However, two or more lenses may be integrated therewith.

Also in the foregoing embodiment, the lens L2 is attached to the output surface of the prism P1. However, the prism and the lens may be integrally molded.

Also in the foregoing embodiment, a piezoelectric element is used as the drive member. However, micromotors or the like may also be used.

Also in the foregoing embodiment, a CCD image sensor is used as the image pickup element. However, MOS image sensors, particularly, CMOS image sensors or the like may also be used.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An electronic image pickup device with a hand-shake compensation function comprising: a bending member for bending an optical axis; a lens system for receiving light derived from the bending member; an image pickup element on which an image of a subject is formed by the light derived from the lens system; and a drive member for driving the bending member, in which upon occurrence of a hand-shake vibration, the bending member is driven by the drive member so that a shift of the subject image is compensated, wherein
the bending member and at least one lens in the lens system are integrated together.

2. The electronic image pickup device with a hand-shake compensation function as claimed in claim 1, wherein the bending member is a prism, and the lens is attached to the prism.

3. The electronic image pickup device with a hand-shake compensation function as claimed in claim 1, wherein the bending member and the lens are fixed to one common fixing member.

4. The electronic image pickup device with a hand-shake compensation function as claimed in claim 3, wherein the bending member is a mirror.

5. A camera-equipped portable electronic device including the electronic image pickup device with a hand-shake compensation function as claimed in claim 1.

6. A camera-equipped portable electronic device including the electronic image pickup device with a hand-shake compensation function as claimed in claim 2.

7. A camera-equipped portable electronic device including the electronic image pickup device with a hand-shake compensation function as claimed in claim 3.

8. A camera-equipped portable electronic device including the electronic image pickup device with a hand-shake compensation function as claimed in claim 4.
